(19) United States
(12) Patent Application Publication
(10) Pub. No.: US 2026/0273549 A1
(43) Pub. Date: Sep. 17, 2026

(54) Variable Cooling System for Strips and Rolls

(71) Applicant: ANDRITZ Metals Germany GmbH, Hemer (DE)

(72) Inventors: Christian Tillmann, Balve (DE); Jan Ottensmeyer, Hagen (DE)

(21) Appl. No.: 19/541,474

(22) Filed: Feb. 17, 2026

(30) Foreign Application Priority Data
Mar. 17, 2025 (AT) 50171/2025A

(51) Int. Cl. B05B 1/30; B05B 1/16; B05B 1/34; B05B 3/06

(52) U.S. Cl. CPC B05B 1/3026; B05B 1/1609; B05B 1/30; B05B 1/3402; B05B 3/06

(57) ABSTRACT

A nozzle beam with a plurality of lateral outlet openings, through which a fluid can be applied to a roll or to a rolled material. The nozzle beam has a longitudinal bore extending within it in an axial direction. The longitudinal bore is connected to lateral outlet openings of the nozzle beam via transverse channels. A control tube with lateral openings in a tubular shell is provided in the longitudinal bore. By rotating or axially displacing the control tube, the lateral openings of the control tube at least partially open the openings to the transverse channels and thus the mass flow of the fluid to the lateral outlet openings can be adjusted. A method for adjusting the mass flow of a fluid to the individual lateral outlet openings of a nozzle beam is also included.

### BACKGROUND

Disclosed herein is a nozzle beam with a plurality of lateral outlet openings, through which a fluid is sprayed or blown onto a roll or onto a rolled material, for example a strip. In this case, the nozzle beam has a fluid connection on its end face, via which the fluid is fed to the longitudinal bore running inside the nozzle beam and reaches the lateral outlet openings via transverse channels.

Also disclosed is a method for adjusting the mass flow of a fluid to the individual lateral outlet openings of a nozzle beam.

Nozzle beams are used in rolling mills, for example, for cooling or lubricating rolls or the rolled material, such as strips or slabs. Oil, water or an emulsion are often used as cooling or lubricating media. However, nozzle beams are also used as blow-off devices or for drying, for which air or another gas is often used as the fluid.

Cooling of the strip is an important issue, especially for reducing mills. Effective cooling has a significant influence on product quality (surface) and output (throughput). The strip must be dried again behind the roll gap. To this end, the aim is to apply all of the cooling medium (e.g., oil) at the inlet of the rolling mill stand, as anything that is not sprayed on at the outlet does not have to be removed later during the strip drying process.

A major problem occurs when the nozzles, for lubricating or cooling the roll gap, spray the oil past the sides of the strip into the outlet.

This could be prevented if the length of the nozzle beam were precisely matched to the width of the strip, but in practice, strips of different widths are often processed using the same rolling mill stand.

In addition, it would also be favorable if the flow rate through the individual spray nozzles could be adjusted or regulated, as a different cooling effect could then be achieved across the roll width or across the strip width. A uniform strip temperature is particularly important in the production of electric strips. As the strips generally experience greater cooling in their lateral edge areas due to convection, it would be advantageous if the spray nozzles applied more cooling medium in the central area of the strip so that the strip has as uniform a temperature as possible across the strip width.

Nozzle beam systems for the selective cooling or lubrication of rolls or strips are already known in the state of the art. EP 4 232 215 B1 describes a modular nozzle beam system in which the nozzle beam can be individually assembled from individual blocks and thus adapted to the respective strip width. However, this system has a complicated design.

It is also known from EP 4 232 215 B1 that individual spray nozzles or groups of spray nozzles can be individually controlled via integrated control valves. However, such solutions are very expensive and error-prone and often cannot be used at all due to the limited installation space.

### SUMMARY

The inventive embodiments are therefore based on providing a nozzle beam, in which the amount of sprayed or blown-on fluid can be changed or adjusted via the strip or roll width, whereby the nozzle beam should have a design that is as simple and space-saving as possible.

As disclosed herein, a control tube with lateral openings in the tubular shell is provided in the longitudinal bore of the nozzle beam, wherein this control tube can be rotated and/or displaced in the longitudinal bore, so that the lateral openings of the control tube can thereby close or open the openings to the transverse channels, whereby the flow rate (mass flow) of the fluid to the lateral outlet openings can be adjusted.

In the embodiments, an outer hollow body with outlet openings (nozzle beam) and an inner hollow body (control tube) with selectively arranged control bores or grooves (lateral openings) are displaced or rotated relative to each other in order to change the flow cross-sections at the individual outlet openings of the nozzle beam with a certain characteristic. This allows the desired control geometry to be realized.

If, for example, the holes in the edge areas of the control tube are offset in the circumferential direction or if the holes in the center area of the control tube are elongated in the circumferential direction, the outer nozzles can be switched off by rotating the control tube.

A nozzle beam of this type has a very simple and compact design.

In a preferred embodiment, the number of lateral openings in the control tube corresponds to the number of transverse channels in the nozzle beam.

In a preferred embodiment, the lateral openings in the center area of the control tube have a different cross-section, in particular a larger cross-section, than in the edge areas of the control tube.

However, in another embodiment, all openings in the control tube have the same cross-section, but are slightly offset along the control tube axis in circumferential direction. Even then, the openings to the individual cross channels can be opened to different extents by rotating the control tube.

The disclosed embodiments also allow changing the amount of coolant supplied over the strip width if a curved control geometry is used, so that, for example, the flow cross-sections increase from the edge area to the center of the nozzle beam.

Alternatively, the system can be used for blowing off. For example, the nozzle beam could be adjusted so that only the edges of the strip are blown off.

If the control geometry decreases from the inside to the outside (from the center area to the edge areas), the outer nozzles can be switched off selectively.

Depending on the direction of rotation, a control tube could also have several control geometries. For example, there could be two or more rows of holes in the control tube.

The lateral openings in the central region of the control tube may, for example, have an elongated cross-section and the openings in the edge region may have a round cross-section, so that the transverse channels in the central region of the nozzle beam are released first by a rotating or by an axial movement of the control tube.

The elongated cross-section of the lateral openings can extend in the circumferential direction of the control tube.

Alternatively, the openings in the center area of the control tube may have an asymmetrical cross-section and the lateral outlet openings also preferably have a different cross-section. In this embodiment, a variety of different adjustment options (control geometries) can be achieved by rotating and axially shifting the control tube.

Also disclosed is a method for adjusting the mass flow of a fluid to the individual lateral outlet openings of the nozzle beam. To adjust the mass flow of the fluid to the lateral outlet openings, the control tube is rotated around its longitudinal axis and/or moved along its longitudinal axis in the longitudinal bore.

By superimposing the sense of rotation with an axial movement, the control geometry can be set with substantial variability.

The preferred fluids for use with the inventive embodiments are oil, water, an emulsion or air.

### BRIEF DESCRIPTION OF THE DRAWINGS

In the following, the invention is described on the basis of drawings in which common reference numerals in the respective figures refer to the same components, wherein:

FIG. 1 shows a schematic arrangement of an embodiment of the disclosed nozzle beam;

FIG. 2 shows a schematic arrangement of the nozzle beam with the control tube shown separately;

FIG. 3 shows examples of different mass flows that can be realized with the nozzle beam.

### DETAILED DESCRIPTION

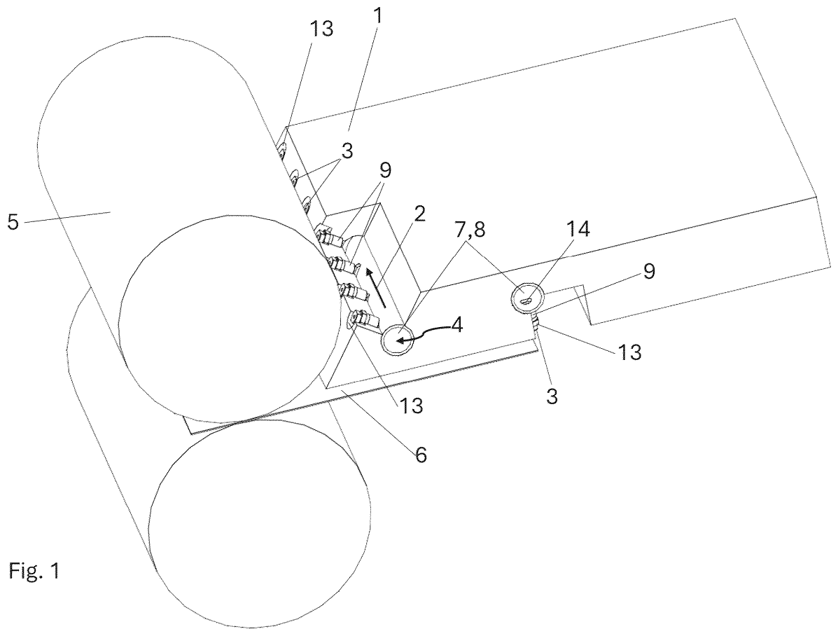

FIG. 1 is a schematic diagram of an embodiment of the nozzle beam 1. A fluid 4, for example water or oil, is sprayed onto a roll 5 or a rolled material 6 via lateral outlet openings 3 or nozzles 13. In this example, the rolled material 6 is a metal strip.

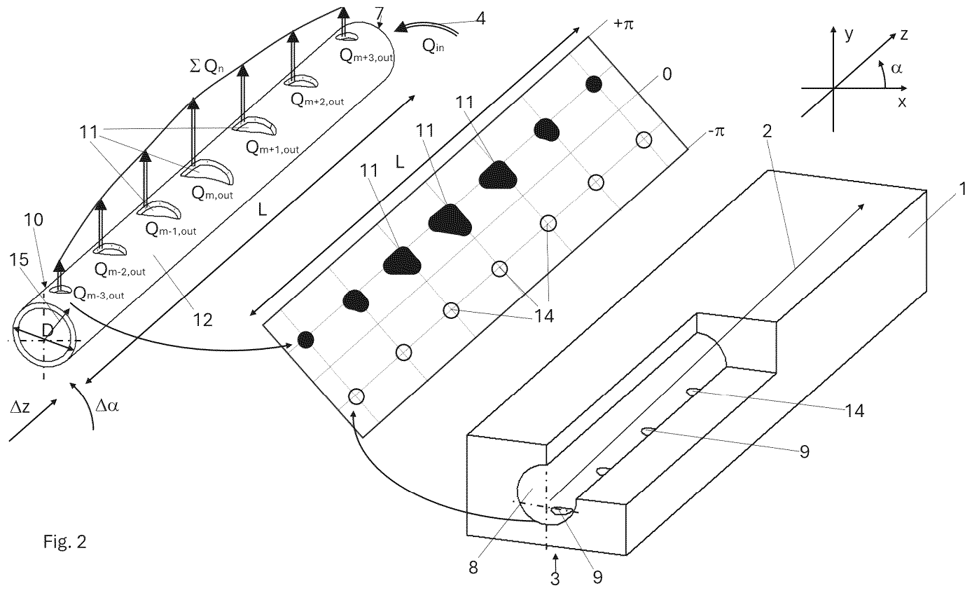

In FIG. 2, the nozzle beam 1 is shown with a partially omitted shell so that the longitudinal bore 8 along the axial extension 2 of the nozzle beam 1 can be better recognized. The openings 14 to the transverse channels 9 through which the fluid 4 reaches the outlet openings 3 or the nozzles 13 can also be clearly seen in the view of FIG. 2. The control tube 10 is typically located in the longitudinal bore 8, but is shown here on the left-hand side for better clarity. The outer diameter of the control tube 10 essentially corresponds to the inner diameter of the longitudinal bore 8. The control tube 10 has a tubular shell 12 in which several lateral openings 11 are arranged.

A fluid 4, for example oil, water or air, is fed into the inside of the control tube 10 at the end face 7 of the nozzle beam 1. Depending on the position of the control tube 10 in the longitudinal bore 8, the fluid 4 can then pass through the openings 14 into the transverse channels 9.

In this example, it can be seen that the lateral bores 11 in the control tube 10 are larger in the center area of the control tube 10 than the bores in the edge areas. In the center illustration in FIG. 2, the cylinder shell surface between the longitudinal bore 8 and the tubular shell 12 is shown to make it easier to understand how the control tube 10 works. The length L of the control tube 10 corresponds to the height of the rolled-out cylinder shell.

In this case, the lateral openings 11 in the tubular shell 12 are shown in black and the openings 14 to the transverse channels 9 are shown as circles. In this example, the openings 11 of the control tube 10 point upwards and the openings 14 in the longitudinal bore point downwards. As there is no overlap between the openings 11 and 14, no fluid can flow through the control tube 10 to the transverse channels 9. If the control tube 10 is rotated by an angle of Δα=180° or by π around its longitudinal axis 15, the openings 11 and 14 would overlap and the fluid 4 would flow to all transverse channels 9. Since the lateral openings 11 in the center area of the control tube 10 are significantly larger than in the edge areas, there are angles of rotation Δα of the control tube 10 at which a fluid passage is only possible to the corresponding transverse channels 9 in the center area of the nozzle beam 1. Depending on the shape or cross-section of the lateral openings 11 of the control tube 10, different mass flows Q to the individual lateral outlet openings 3 of the nozzle beam 1 can thus be achieved for different angles of rotation α.

These adjustable different mass flows Qₘ are shown here as examples for a defined angle of rotation Δα by arrows of different lengths.

A different mass flow to the individual nozzles 13 can also be achieved by an axial displacement Δz of the control tube 10 in the longitudinal bore 8.

The mass flow Qₘ flowing out of the lateral outlet openings 3 thus depends on the angle of rotation Δα and on the size of the axial displacement Δz of the control tube 10.

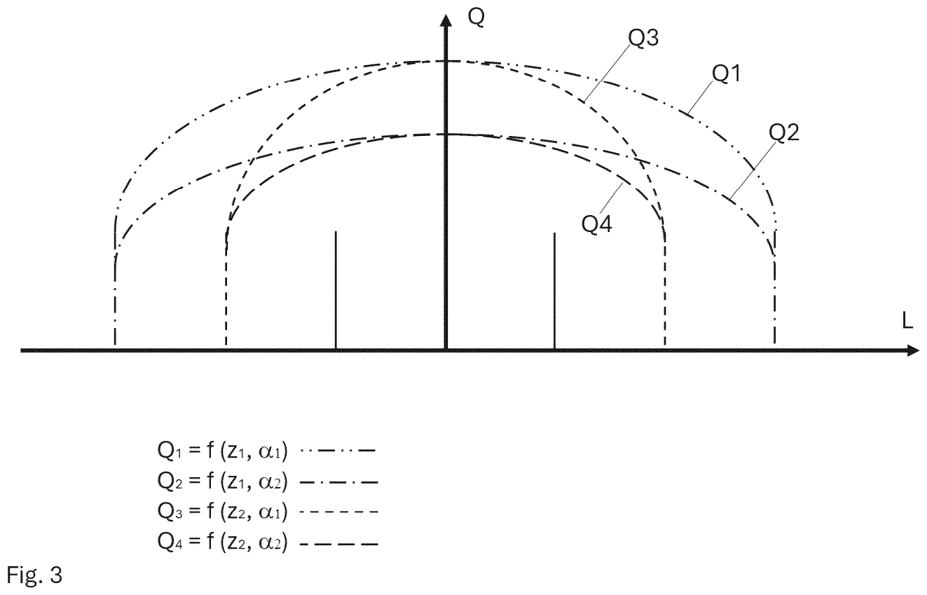

FIG. 3 shows four exemplary different mass flows Qₘ along the length L of the control tube 10. In this design example, the control tube 10 has side openings 11 of different sizes, as shown in FIG. 2.

The individual mass flows Q₁, Q₂, Q₃ and Q₄ depend on the angle of rotation a and on the axial position z of the control tube 10 in the longitudinal bore 8. For the mass flows Q₁ and Q₂, the axial position Z₁ of the control tube 10 is the same, but the respective angle of rotation α₁ and α₂ is different. Here, the lateral openings 11 in the center area of the control tube 10 overlap more with the openings 14 to the transverse channels 9 than in the two edge areas. This means that the mass flow Q in the center area of the nozzle beam 1 is greater than in the edge areas. This means that more fluid 4 can be applied to a roll 5 or a rolled material 6 in the center area, with the application extending over the entire length L of the nozzle beam. At the angle of rotation α₁, the openings 11 of the control tube 10 overlap more with the openings 14 than at the angle of rotation α₂, as a result, the mass flow Q₁ to the individual outlet openings 3 is greater than the mass flow Q₂. For the mass flows Q₃ and Q₄ the respective angle of rotation α₁ and α₂ is the same as for the mass flows Q₁ and Q₂, however, the control tube 10 is now at position Z₂. The control tube 10 has therefore also been shifted in the axial direction 2.

At mass flows Q₃ and Q₄, the control tube 10 is now shifted in axial direction 2 to such an extent that the lateral openings 11 of the control tube 10 no longer overlap with the openings 14 to the transverse channels 9 in the edge areas. As a result, no more fluid 4 reaches the outlet openings 3 in the edge areas and the edge nozzles 13 are switched off. With this setting, the edge nozzles 13 may be switched off and more fluid 4 applied in the center area. A curved steering geometry is thus realized here by the control tube 10.

The embodiments shown in the drawings merely constitute a preferred embodiment of the invention. Due to the corresponding design of the lateral openings 11 and corresponding angles of rotation a and axial positions z, a wide variety of mass flows Q can of course be achieved over the length of the beam L.

### Reference Numerals

1 Nozzle beam
2 axial extension, axial direction of the nozzle beam
3 lateral outlet opening
4 Fluid
5 Roll
6 Rolled material (strip)
7 End face of the nozzle beam 1
8 Longitudinal bore
9 Transverse channels
10 Control tube
11 lateral openings in tubular shell 12 of the control tube 10
12 Tubular shell
13 Nozzles
14 Opening to the transverse channels 9
15 Longitudinal axis of the control tube 10
L Length of the control tube 10
Δα Angle of rotation
Q Mass flow
Qᵢₙ Total mass flow supplied to the control tube 10
ΣQₙ Total mass flow through the side openings 11
Δz Displacement in the axial direction
X, y, z Coordinate system

What is claimed is:

1. A nozzle beam (1) for applying a liquid or gaseous fluid (4) to a roll (5) or rolled material (6), the nozzle beam (1) defining an axial extension (2), comprising
a longitudinal bore (8) extending in the axial direction;
an end face (7) with a fluid connection opening into the longitudinal bore (8);
a control tube (10) comprising a tubular shell (12) with lateral openings (11) provided in the longitudinal bore (8);
a plurality of lateral outlet openings (3) along the axial extension (2) through which the liquid or gaseous fluid (4) can be applied to the roll (5) or rolled material (6), wherein
the longitudinal bore (8) is connected to the lateral outlet openings (3) of the nozzle beam (1) via openings (14) to form transverse channels (9),
rotating or axially displacing the control tube (10) within the longitudinal bore (8) cause at least one of the openings (11) of the control tube (10) to at least partially overlap one of the openings (14), thereby opening the respective opening (14) to the transverse channels (9), thereby permitting adjustability of a mass flow Q of the fluid (4) to the lateral outlet openings (3).

2. The nozzle beam (1) according to claim 1, wherein a number of lateral openings (11) of the control tube (10) corresponds to a number of transverse channels (9) of the nozzle beam (1).

3. The nozzle beam (1) according claim 2, wherein lateral openings (11) located in an axially central region of the control tube (10) have a different cross-section than lateral openings (11) in an edge region of the control tube (10).

4. The nozzle beam (1) according to claim 1, wherein lateral openings (11) located in an axially central region of the control tube (10) have a different cross-section than lateral openings (11) in an edge region of the control tube (10).

5. The nozzle beam (1) according to claim 4, wherein the lateral openings (11) located in the axially central region have a larger cross-section than the lateral openings (11) in the edge region.

6. The nozzle beam (1) according to claim 2, wherein
the lateral openings (11) in an axially central region of the control tube (10) have an elongated cross-section, and
the lateral openings (11) in an edge region of the control tube (10) have a round cross-section, such that transverse channels (9) in the axially central region of the nozzle beam (1) are released before transverse channels (9) in the edge region by a rotating or by an axial displacement of the control tube (10) within the longitudinal bore (8).

7. The nozzle beam (1) according to claim 1, wherein
the lateral openings (11) in an axially central region of the control tube (10) have an elongated cross-section, and
the lateral openings (11) in an edge region of the control tube (10) have a round cross-section, such that transverse channels (9) in the axially central region of the nozzle beam (1) are released before transverse channels (9) in the edge region by a rotating or by an axial displacement of the control tube (10) within the longitudinal bore (8).

8. The nozzle beam (1) according to claim 7, wherein the elongated cross-section of the lateral openings (11) extends in the circumferential direction of the control tube (10).

9. The nozzle beam (1) according to claim 1, wherein the lateral openings (11) in an axially central region of the control tube (10) have an asymmetrical cross-section.

10. The nozzle beam (1) according to claim 9, wherein the lateral openings (11) in the axially central region have an elongated cross-section that extends in the circumferential direction of the control tube (10).

11. The nozzle beam (1) according to claim 2, wherein the lateral openings (11) in an axially central region of the control tube (10) have an asymmetrical cross-section.

12. The nozzle beam (1) according to claim 4, wherein the lateral openings (11) in the axially central region have an asymmetrical cross-section.

13. The nozzle beam (1) of claim 1, wherein the liquid or gaseous fluid (4) comprises oil, water, an emulsion or air.

14. A method for adjusting the mass flow Q of a fluid (4) to individual lateral outlet openings (3) of a nozzle beam (1) according to claim 1, comprising:
rotating the control tube (10) about its longitudinal axis (15), or
axially displacing the control tube (10) in the longitudinal bore (8), or
rotating the control tube (10) about its longitudinal axis (15) and axially displacing the control tube (10) in the longitudinal bore (8).

15. The method for adjusting the mass flow Q of a fluid (4) according to claim 14, wherein the fluid comprises oil, water, an emulsion or air.

16. The method for adjusting the mass flow Q of a fluid (4) according to claim 14, wherein a number of lateral openings (11) of the control tube (10) corresponds to a number of transverse channels (9) of the nozzle beam (1).

17. The nozzle beam (1) according to claim 16, wherein lateral openings (11) located in an axially central region of the control tube (10) have a different cross-section than lateral openings (11) in an edge region of the control tube (10).
